(19) United States
(12) Patent Application Publication
(10) Pub. No.: US 2026/0247267 A1
(43) Pub. Date: Aug. 20, 2026

(54) SYSTEMS AND METHODS FOR PRIORITY SERVICE BASED ON NETWORK SLICING

(71) Applicant: T-MOBILE INNOVATIONS LLC, Overland Park, KS (US)

(72) Inventors: Anis Adil Anis, Bay Point, CA (US); Sumanth Bellam Hemanth, Bothell, WA (US); Cristian Asandului, Snoqualmie, WA (US); Brent Matthew Johnston, Ardmore, AL (US)

(21) Appl. No.: 19/056,465

(22) Filed: Feb. 18, 2025

(51) Int. Cl. H04W 48/18; H04W 8/18; H04W 72/566

(52) U.S. Cl. CPC H04W 48/18; H04W 8/18; H04W 72/566

(57) ABSTRACT

Systems, methods, and software are disclosed herein for enabling Wireless Priority Service using network slices wireless communication networks in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to receive an access request for network service for a UE and identify priority status of a subscriber profile of the UE. The program instructions further direct the computing apparatus to assign a dedicated network slice based on the priority status and enable the network service for the UE in accordance with the dedicated network slice.

### TECHNICAL FIELD

Aspects of the disclosure are related to the field of wireless communication networks, particularly priority service for IP data traffic.

### BACKGROUND

Wireless Priority Service (WPS) is a program for giving priority access to emergency responders, key government officials and critical infrastructure personnel to cellular networks during emergencies. WPS is natively supported in LTE networks through priority call handling mechanisms that enable authorized users to place calls with higher precedence during network congestion. WPS on LTE networks provides the authorized users with prioritized call access during network congestion by assigning a higher priority to call setup requests, ensuring improved call completion rates for emergency and critical communications. However, WPS on LTE is limited by its reliance on priority call queuing rather than preemption, meaning that during extreme congestion, call completion is not guaranteed if network resources are fully allocated. Moreover, because mission-critical communications are not limited to voice calls, a congested network may also constrain the transmission of mission-critical data communications (e.g., video data, imaging data, emergency medical data, telemetry data) as well.

As wireless networks deploy 5G networks alongside LTE networks, the broader reach of the 5G networks enables enhanced connectivity through improved spectrum utilization, higher data throughput, lower latency, and more efficient resource allocation (e.g., through beamforming technology, dynamic spectrum sharing, etc.). On 5G Non-Standalone (5GNSA) networks, WPS is supported by leveraging the LTE evolved packet core (EPC) for call control and prioritization while utilizing 5G radio access for enhanced coverage and performance. However, since 5GNSA networks use LTE’s native support for WPS, WPS calls are still subject to the same congestion and resource allocation challenges as LTE, limiting their effectiveness under extreme network load.

### OVERVIEW

Technology is disclosed herein for Wireless Priority Service using network slices wireless communication networks in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to receive an access request for network service for a UE and identify priority status of a subscriber profile of the UE. The program instructions further direct the computing apparatus to assign a dedicated network slice based on the priority status and enable the network service for the UE in accordance with the dedicated network slice.

In another example, a method of operating a wireless network comprises receiving an access request for network service for a UE and identifying priority status of a subscriber profile associated with the UE. The method further comprises assigning a dedicated network slice based on the priority status and enabling the network service for the UE in accordance with the dedicated network slice.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for enabling priority service using network slices in an implementation.

FIG. 2 illustrates a process for enabling priority service using network slices in an implementation.

FIG. 3 illustrates an operational environment for priority service using network slices in an implementation.

FIG. 4 illustrates an additional operational environment for priority service using network slices in an implementation.

FIGS. 5A and 5B illustrate workflows for priority service using network slices in an implementation.

FIGS. 6A and 6B illustrate implementations of network slices for enabling priority service.

FIG. 7 illustrates an operational architecture of a wireless communication network in an implementation.

FIG. 8 illustrates an operational architecture for a wireless communication network in an implementation.

FIG. 9 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5GNR (including 5GNSA and 5GSA) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Various implementations are disclosed herein for prioritizing WPS calls on networks lacking native WPS support, such as 5G standalone (5GSA) networks. In various implementations, when a call is placed by a user from a 5G-enabled device on a 5GSA wireless network, the network checks the user’s profile for an assigned Service Offer Code (SOC) that indicates an WPS authorization. If the SOC is present, the 5G core assigns a network slice to the call that prioritizes the voice, video and data transmissions associated with call. The network slice assigned to the WPS call is based on 5G Quality of Service (QoS) Identifiers (5QI) classes which map to native WPS functionality, prioritizing voice, video, and data over data traffic of other network slices, including enabling preemption. The mapping of native WPS functionalities to QoS policies can include policies such as prioritizing voice transmissions, IMS signaling, real-time video, low-latency data, and high-priority data. Thus, although a 5GSA network may lack the capability for dedicated bearers for WPS voice traffic, the WPS requirements can be mapped to 5QI classes so that the WPS calls on the 5GSA network still obtain prioritized access to network resources commensurate with or even better than that of native WPS support on LTE or 5GNSA networks. Moreover, by enabling WPS service via a network slice for priority service, compatibility between networks of different architectures is maintained.

In a brief example of the technology disclosed herein, when an emergency call is received from a user equipment (UE), such as a call by a first responder using a mobile phone, the UE attaches to a radio access network (RAN) (e.g., cell tower, orbiting cell). The wireless network identifies the call as a WPS call based on an SOC in the subscriber profile of the UE. The wireless network provisions network resources of the RAN and the packet core network for the call according to a network slice defined for WPS calls. A voice bearer of the call is hosted by the data plane of the 5G network to the IMS core of the network; other data transmissions (e.g., video, application data) may be carried by a data bearer to an application server, an external data network, etc., via wireless/wired communication networks (e.g., the Internet). The network slice for the voice and data transmissions to/from the UE include prioritized access to network resources with respect to bandwidth, throughput, latency, and other parameters.

Technical effects of the technology disclosed herein include providing a seamless transition of WPS service between LTE and 5GNSA networks and 5GSA networks which maintains or improves the prioritized access of WPS calls to network resources and maintains forward- and backward-compatibility between the different network architectures. Thus, when a WPS call from a first responder attaches to a radio access network of a 5GSA network, the WPS call receives the same QoS as if it had attached to a WPS-enabled network. In addition, if the first responder travels from the coverage area of an LTE access point to a 5GSA access point, the WPS call can be transitioned from the native WPS service of the LTE access point to the non-native WPS-quality service of the 5GSA access point with no loss of prioritized access.

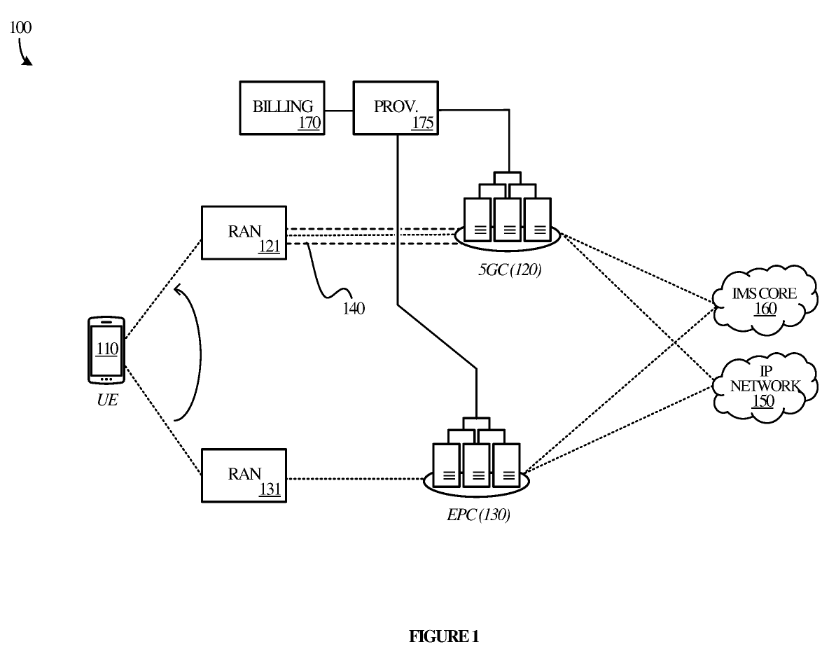

Turning now to the Figures, FIG. 1 illustrates operational environment 100 for supporting WPS service in wireless communication networks in an implementation. Operational environment 100 includes user equipment (UE) 110, radio access nodes (RANs) 121 and 131, 5GC network 120, EPC network 130, network slice 140, IP network 150, IMS core 160, billing module 170, and provisioning module 175.

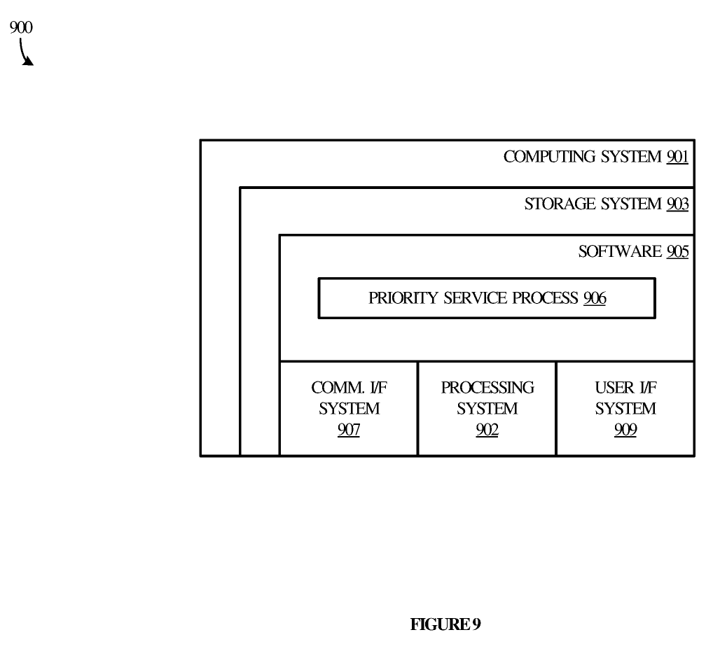

User equipment 110 is representative of a device, such as a smartphone, computer, sensor, controller, radio, and/or some other user apparatus, with processing circuitry for wireless communication with wireless networks using protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 110 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 901 in FIG. 9 is broadly representative. UE 110 exchanges wireless communication signals with RAN 121 of 5GC network 120 and RAN 131 of EPC network 130 over radio frequency bands.

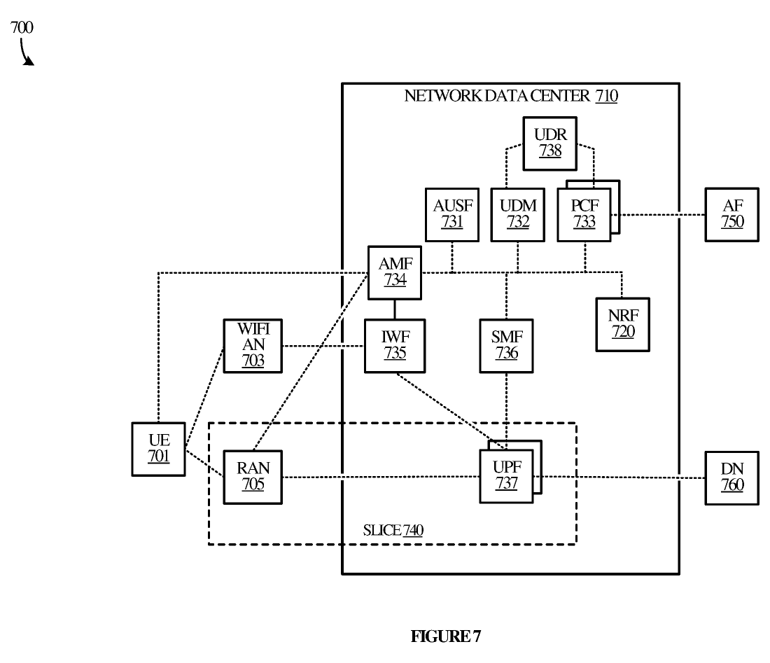

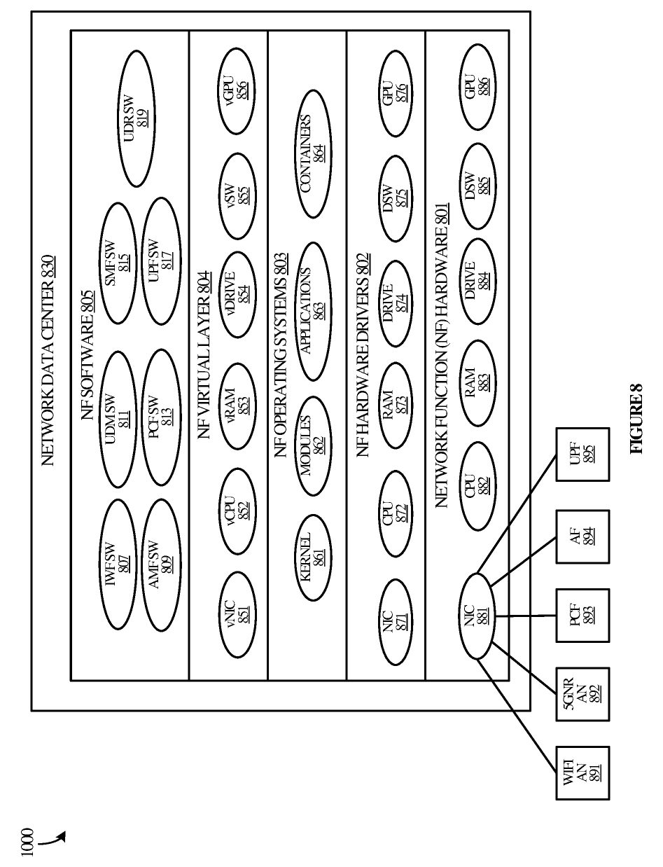

5GC network 120 is representative of a wireless communication network core capable of using a Fifth Generation New Radio (5G-NR), 6G, or other protocol to communicate with computing devices such as UE 110. In an implementation, 5GC network 120 is representative of a service-based architecture (SBA) which includes network functions which constitute the control plane and user/data plane of a wireless communication network core, of which network data center 710 of FIG. 7 and network data center 830 of FIG. 8 are representative. For example, 5GC network 120 may be a 5G Standalone (5GSA) network. The network functions of 5GC network 120 are implemented on one or more suitable computing devices, of which computing device 901 of FIG. 9 is representative. Examples of suitable computing devices include server computers, blade servers, and the like. The network elements of 5GC network 120 may be implemented in the context of one or more data centers in a co-located or distributed manner, or in some other arrangement.

EPC network 130 is representative of a wireless communication network core capable of using a Fifth Generation New Radio (5G-NR), LTE, 6G, or other protocol to communicate with computing devices such as UE 110 and which supports WPS service using QoS Class Identifiers (QCIs) for WPS. In an implementation, EPC network 130 is representative of a network architecture based on an evolved packet core architecture which uses dedicated interfaces between network functions to manage network access, mobility, and data transmission. For example, EPC network 130 may be an evolved packet core (EPC) of an LTE network or a 5G Non-Standalone (5GNSA) network.

Network slice 140 exemplifies an instance of network resource allocation operating on the physical network infrastructure of an SBA network such as 5GC network 120. Network slice 140 includes a dedicated allocation of resources, such as bandwidth, processing power, and robust security measures. The security measures of network slice 140 can include advanced encryption protocols, secure access controls, and continuous monitoring to detect and mitigate threats or potential threats. By managing network slice 140 independently of other network slices (not shown), network slice 140 provides a secure and isolated environment for operations hosted by the slice including safeguarding sensitive data and maintaining the integrity of the network. Network slice 140 may be optimized for a particular type of use, such as providing service commensurate with WPS as supported by a WPS-enabled network such as EPC network 130. The control plane (not shown) of 5GC network 120 manages network slicing, including time-bound dynamic slicing, and network slice selection and allocation, that is, selecting or allocating of network slice 140 for hosting service between UE 110 and destinations such as IP network 150 or IMS core 160 in accordance with WPS policies.

In an implementation, network slice 140 is defined or provisioned with a set of 5G QoS Identifiers (5QIs) tailored for WPS-level service, with each 5QI class mapped to priority levels and latency requirements for prioritizing WPS traffic in congested network conditions. For example, the 5QI requirements of network slice 140 may correspond to each of the QCIs specified for WPS calls on an LTE or 5GNSA network.

In an exemplary implementation, the 5QI classes of network slice 140 for WPS service can include classes 1, 2, 5, and 65. For voice and emergency call services, 5QI 1 is designed for conversational real-time traffic with ultra-low latency and guaranteed packet delay budgets. For mission-critical video and push-to-talk (MCPTT) applications, 5QI 2 specifies high-reliability transmission with stringent jitter and loss constraints. To accommodate signaling and control plane messaging, such as IMS registration and call setup, 5QI 5 enables low-latency SIP signaling exchanges. For high-priority IP-based messaging, 5QI 65 (corresponding to QCI 6), specifies rapid delivery of emergency texts and alerts. Other 5QI class sets or configurations for WPS-level are possible. For example, network slice 140 may also include 5QI 0 for ultra-low latency service, 5QI 3 for real-time video transmissions, 5QI 4 for non-critical video transmissions, or 5QI 69 for government priority traffic.

RANs 121 and 131 are representative of access nodes by which to connect UEs with wireless network cores, such as access nodes of Fifth Generation (5G) RANs, access nodes of long-term evolution (LTE) RANs, gNodeBs, eNodeBs, macrocells, NB-IoT access nodes, LP-WAN base stations, wireless relays, Wifi access nodes, and/or other wireless or wireline network transceivers. RANs 121 and 131 host access networks using radio frequencies to provide wireless network connectivity to devices. To communicate with a network core such as 5GC network 120 or EPC network 130, RANs 121 and 131 include receiving unit (RU) circuitry which communicates along fronthaul data paths to distributed unit (DU) circuitry which in turn communicates with central unit (CU) circuitry along midhaul data paths. Although commonly seen as cell towers, RANs 121 and 131 can include physical configurations which are terrestrial, non-terrestrial, or hybrid terrestrial-non-terrestrial. Terrestrial configurations can include rooftop installations, small-cell sites, distributed antenna systems, vehicle-mounted systems, and the like, while non-terrestrial configurations can include space-based (e.g., satellite-based) access nodes or airborne access nodes.

Billing module 170 is representative of a functionality implemented in software or hardware for registering WPS service with the account or plan associated with a UE such as UE 110. Billing module 170 may include functionality for confirming WPS eligibility of a UE and coordinating with provisioning module 175 to ensure that WPS-eligible devices receive the necessary network settings and QoS configurations for WPS service. Billing module 170 may also include functionality for assigning an SOC for WPS service to the UE (e.g., to the subscriber account of the UE). In an implementation, an SOC for WPS includes a unique identifier in a subscriber’s profile that defines the specific services, entitlements, and priority levels that the subscriber UE is authorized to access within a network, such as WPS priority handling, IMS voice services, or access to a dedicated network slice for WPS.

Provisioning module 175 is representative of a functionality implemented in software or hardware for pushing configuration updates to a UE based on an indication or confirmation of WPS eligibility for the device from billing module 170. Provisioning module 175 may also include functionality for interfacing with a subscriber database (e.g., an HSS or UDM) to update and synchronize subscriber data including the assigned SOC for WPS across 5GC network 120 or EPC network 130.

IP network 150 is representative of an external packet data network that interfaces with a wireless communication network core for providing connectivity for user data sessions, enterprise applications, IMS services, cloud services, and other IP-based communications. EPC network 130 connects to IP network 150 via a Packet Data Network Gateway (PGW) (not shown) which serves as the entry point for IMS signaling. 5GC network 120 connects to IP network 150 via a User Plane Function (UPF) (not shown) which handles packet forwarding and routing for IMS-based communication over the 5G network. A Policy Control Function (PCF) (not shown) in 5GC network 120 enforces QoS policies for IMS traffic.

IMS core 160 is representative of an IMS-based communication system or platform for voice, video, messaging, mission-critical push-to-talk (MCPTT), and other real-time multimedia service over an IP network, including supporting session control, media negotiation, and policy enforcement for real-time communication (RTC) across various network environments.

In a brief operational scenario of operational environment 100, a user or subscriber associated with UE 110 qualifies for WPS service. Upon verifying the WPS status of a subscriber profile of UE 110, billing module 170 propagates the WPS status of UE 110 to the subscriber databases of a wireless network (e.g., 5GC network 120, EPC network 130) via provisioning module 175. For example, provisioning module 175 may update the subscriber profile of UE 110 in a UDM of 5GC network 120 or a Home Subscriber Server (HSS) of EPC network 130 to store an SOC for WPS service and priority attributes in association with UE 110 in the database(s). Provisioning module 175 may also push a configuration update to UE 110 which includes QoS parameters, Access Class Barring (ACB) exemptions, IMS settings for Voice Over LTE (VoLTE) or Voice over New Radio (VoNR) support, and dialing instructions for WPS call initiation.

With a WPS authorization registered with EPC network 130 and 5GC network 120, UE 110 connects with RAN 131 (e.g., an eNodeB cell) for IMS service, e.g. to place a WPS voice call. (The user may indicate the WPS status associated with the call by prepending a specified code to the destination number.) UE 110 registers with a Mobility Management Entity (MME) of EPC 130, which processes the attach request and retrieves the subscriber profile from the HSS. The MME identifies or verifies the WPS status of the inbound call based on the SOC associated with UE 110’s profile. Upon detecting the WPS designation, the MME assigns a dedicated bearer with a high-priority Allocation and Retention Priority (ARP) value to expedite call setup. Once the call setup is complete, the Serving Gateway (SGW) and Packet Gateway (PGW) route the WPS call toward IMS core 160. The PGW forwards IMS-bound traffic to the Proxy Call Session Control Function (P-CSCF), which manages SIP signaling to connect the call with a Public Safety Answering Point (PSAP), another UE, or similar endpoint.

Continuing the operational scenario of FIG. 1, UE 110 moves to a new location during the call and attaches to 5GC network 120 via RAN 121 (e.g., a gNodeB cell). When the WPS call is handed over from EPC network 130 to 5GC network 120, an MME of EPC network 130 initiates the handover by sending a handover request to an Access and Mobility Management Function (AMF) in 5GC network 120 including the subscriber’s SOC. The AMF queries a UDM of 5GCnetwork 120 to validate the subscriber’s WPS authorization and retrieve the corresponding 5G QoS Identifier (5QI) and priority settings. A Network Slice Selection Function (NSSF) of 5GC network 120 selects network slice 140 for priority communications based on the authorization. A Session Management Function (SMF) of 5GCnetwork 120 establishes a PDU session within the WPS slice, mapping the voice bearer parameters from EPC network 130 to a high-priority 5QI flow with appropriate preemption settings. The UPF of 5GC network 120 routes the traffic with low-latency handling, while the IMS session is maintained for VoNR.

In various implementations, the handover request is received for network service for transmissions other than IMS transmissions, such as IP traffic from UE 110. IP traffic can include Internet of Things (IoT) telemetry, emergency alert messaging, streaming media, or cloud-based application access. In some scenarios, rather than receiving a handover request to continue a call (or other service) from a UE 110, the request for network service is a registration request received from UE 110.

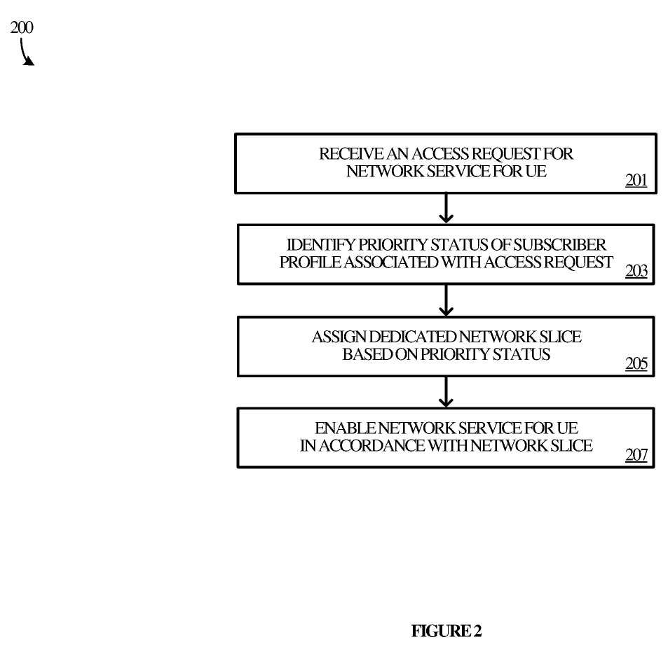

FIG. 2 illustrates a method for enabling WPS-level service on a wireless communication network in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, the computing device receives an access request for network service for a UE (step 201). In an implementation, a UE transmits an access request to a wireless network for network service. For example, the UE may request network access for an IMS transmission (e.g., voice call, real-time videoconference) or for data transmission (e.g., for access to an IP network). The wireless network may be an SBA network which uses network slicing to allocate network resources dynamically based on service requirements, i.e., QoS requirements, according to the use case. In some scenarios, the access request can be handover request from another network to transition a bearer to a PDU session. For example, the user of the UE may be mobile and moving from one network coverage area to another. In other scenarios, the access request may be a registration request received from the UE for a new PDU session.

The computing device identifies a priority status of a subscriber profile associated with the access request (step 203). In an implementation, when the user of the UE prepends a WPS prefix to a telephone number, the wireless network recognizes that the call requires priority handling and verifies that the UE is authorized for WPS service by checking the subscriber profile in a subscriber database, e.g., a UDM. In some scenarios, the UE may request WPS service on the network for data transmissions from the UE, such as application data, telemetry data, and the like.

The computing device assigns a dedicated network slice to the access request based on the priority status (step 205). Once the WPS authorization of the UE has been verified, a network function for slice selection, e.g., a Network Slice Selection Function (NSSF), evaluates the subscriber profile and selects a network slice dedicated for WPS traffic on the basis of the WPS SOC in the profile

The computing device enables network service for the UE in accordance with the network slice (step 207). In an implementation, an IMS-based session for real-time communication (RTC) or PDU session for data traffic is established within a dedicated network slice for WPS. In various implementations, the dedicated network slice provisions network resources to meet QoS standards (e.g., bandwidth, latency, priority handling, packet loss, jitter, reliability) which are mapped from QCI standards for WPS calls. The dedicated network slice may also be reserved solely for authorized WPS transmissions, i.e., IMS communication sessions or PDU sessions. For example, the NSSF may disqualify the WPS call or data transmission session from being established in the dedicated network slice if the UE is not authorized for WPS service. In enabling network service for the UE in accordance with the network slice, the UE is granted access to network resources within the selected slice to ensure that the UE receives the appropriate QoS, bandwidth, priority handling, etc. in accordance with WPS requirements.

Referring once again to FIG. 1, a brief example of process 200 as employed by elements of operational environment 100 follows. In operation, UE 110 is attached to EPC network 130 via RAN 131 for a WPS call. During the call, UE 110 moves into the coverage area of RAN 121. 5GC network 120 receives a handover request for UE 110 from EPC network 130. In response to the handover request, 5GC network 120 verifies the authorization for WPS service based on the user profile of UE 110, where the user profile includes a WPS SOC. 5GC network 120 assigns network slice 140 for WPS to the handover request based on the priority status of UE 110 and enables network service for UE 110 accordingly.

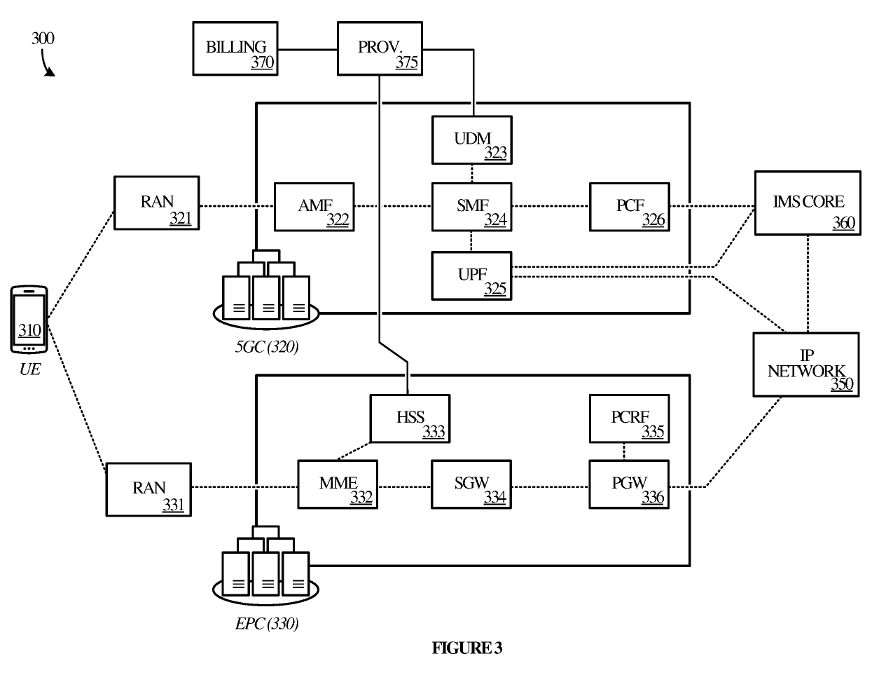

Turning now to FIG. 3, operational environment 300 for engaging WPS service in wireless communication networks in an implementation. Operational environment 100 includes UE 310, RAN 321, RAN 331, 5GC network 320, EPC network 330, network slice 340, IP network 350, IMS core 360, billing module 370, and provisioning module 375. 5GC network 320 includes AMF 322, UDM 323, SMF 324, UPF 325, and PCF 326. EPC network 330 includes MME 332, HSS 333, SGW 334, PCRF 335, and PGW 336.

User equipment 310 is representative of a device, such as a smartphone, computer, sensor, controller, radio, and/or some other user apparatus, with processing circuitry for wireless communication with wireless communication networks using protocols such as Fifth Generation New Radio (5GNR), 5G Advanced, LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). UE 310 can include devices such as Internet of Things (IoT) devices, wearable devices, smart vehicles, robots, sensors, augmented or virtual reality devices, and the like, such as a laptop or desktop computer, or mobile computing device, such as a tablet computer or cellular phone, of which computing system 901 in FIG. 9 is broadly representative. User equipment 310 exchanges wireless communication signals with RAN 321 of 5GC network 320 and RAN 331 of EPC network 330 over radio frequency bands.

5GC network 320 is representative of a wireless communication network capable of using a Fifth Generation New Radio (5G-NR), 6G, or other protocol to communicate with computing devices such as user equipment 310. In an implementation, 5GC network 320 includes an SBA with network functions which constitute the control plane and user/data plane of a wireless communication network core, of which network data center 710 of FIG. 7 and network data center 830 of FIG. 8 are representative. For example, 5GC network 320 may be a 5G Standalone (5GSA) network. The network functions of 5GC network 320 are implemented on one or more suitable computing devices, of which computing device 901 of FIG. 9 is representative. Examples of suitable computing devices include server computers, blade servers, and the like. The network elements of 5GC network 320 may be implemented in the context of one or more data centers in a co-located or distributed manner, or in some other arrangement.

EPC network 330 is representative of a wireless communication network with an evolved packet core architecture which is capable of using a Fifth Generation New Radio (5G-NR), LTE, 6G, or other protocol to communicate with computing devices such as user equipment 310 and which implements WPS using QoS Class Identifiers (QCIs) for WPS. For example, EPC network 330 may be an LTE network or a 5G Non-Standalone (5GNSA) network.

Network slice 340 is representative of an instance of network resource allocation operating on the physical network infrastructure of an SBA network such as 5GC network 320. Network slice 340 includes a dedicated allocation of resources, such as bandwidth, processing power, and enhanced security measures. Enhanced security measures of network slice 340 can include advanced encryption protocols, secure access controls, and continuous monitoring to detect and mitigate potential threats. Network slice 340 may be managed independently of other network slices (not shown) to ensure a secure and isolated environment for operations hosted by the slice.

Additionally, network slice 340 may be optimized for a particular type of use, such as providing service commensurate with WPS as supported by a WPS-enabled network such as EPC network 330. The control plane (not shown) of 5GC network 320 manages network slicing, including time-bound dynamic slicing and network slice selection and allocation. For example, a control plane function of 5GC network 320 may select or allocate network slice 140 for hosting service between UE 310 and destinations such as IP network 350 or IMS core 360 in accordance with WPS policies.

In an implementation, network slice 340 is defined or provisioned with a set of 5G QoS Identifiers (5QIs) tailored for WPS, with each 5QI class mapped to priority levels and latency requirements for prioritizing WPS traffic in congested network conditions. For example, the 5QI requirements of network slice 340 may correspond to each of the QCIs specified for WPS calls on an LTE or 5GNSA network.

In an exemplary implementation, the 5QI classes of network slice 340 for WPS service can include classes 1, 2, 5, and 65. For voice and emergency call services, 5QI 1 is designed for conversational real-time traffic with ultra-low latency and guaranteed packet delay budgets. For mission-critical video and push-to-talk (MCPTT) applications, 5QI 2 specifies high-reliability transmission with stringent jitter and loss constraints. To accommodate signaling and control plane messaging, such as IMS registration and call setup, 5QI 5 enables low-latency SIP signaling exchanges. For high-priority IP-based messaging, 5QI 65 (corresponding to QCI 6), specifies rapid delivery of emergency texts and alerts. Other 5QI class sets or configurations for WPS-level are possible. For example, network slice 340 may also include 5QI 0 for ultra-low latency service, 5QI 3 for real-time video transmissions, 5QI 4 for non-critical video transmissions, or 5QI 69 for government priority traffic.

RANs 321 and 331 are representative of equipment, such as access nodes of 5G RANs, access nodes of LTE RANs, gNodeBs, eNodeBs, macrocells, NB-IoT access nodes, LP-WAN base stations, wireless relays, Wifi access nodes, and/or other wireless or wireline network transceivers. RANs 321 and 331 host access networks using radio frequencies to provide wireless network connectivity to devices. To communicate with a wireless network such as 5GC network 320 or EPC network 330, RANs 321 and 331 include receiving unit (RU) circuitry which communicates along fronthaul data paths to distributed unit (DU) circuitry which in turn communicates with central unit (CU) circuitry along midhaul data paths. RANs 321 and 331 can include physical configurations which are terrestrial, non-terrestrial, or hybrid terrestrial-non-terrestrial. Terrestrial configurations can include cell towers, rooftop installations, small-cell sites, distributed antenna systems, vehicle-mounted systems, and the like, while non-terrestrial configurations can include space-based (e.g., satellite-based) access nodes or airborne access nodes.

Billing module 370 is representative of a functionality implemented in software or hardware for registering a WPS status with the account or plan associated with a UE such as UE 310. Billing module 370 may include functionality for confirming WPS eligibility of a UE and coordinating with provisioning module 375 to ensure that WPS-eligible devices receive the necessary network settings and QoS configurations for WPS service. Billing module 370 may also include functionality for assigning an SOC for WPS service to the UE (e.g., to the subscriber account of the UE).

Provisioning module 375 is representative of a functionality implemented in software or hardware for pushing configuration updates to a UE based on an indication or confirmation of WPS eligibility for the device from billing module 370. Provisioning module 375 may also include functionality for interfacing with an HSS or UDM to update and synchronize subscriber data including the assigned SOC across 5GC network 320 or EPC network 130.

IP network 350 is representative of an external packet data network that interfaces with a wireless communication network core for providing connectivity for user data sessions, enterprise applications, IMS services, cloud services, and other IP-based communications. EPC network 330 connects to IP network 350 via a Packet Data Network Gateway (PGW) (not shown) which serves as the entry point for IMS signaling. 5GC network 320 connects to IP network 350 via a User Plane Function (UPF) (not shown) which handles packet forwarding and routing for IMS-based communication over the 5G network. A Policy Control Function (PCF) (not shown) in 5GC network 320 enforces QoS policies for IMS traffic.

IMS core 360 is representative of an IMS-based communication system or platform for voice, video, messaging, mission-critical push-to-talk (MCPTT), and other real-time multimedia service over an IP network, including supporting session control, media negotiation, and policy enforcement for real-time communication (RTC) across various network environments.

In a brief operational scenario of operational environment 300, a user or subscriber associated with UE 310 is authorized for WPS service. Upon verifying the WPS status of UE 310, provisioning module 375 propagates the WPS status of UE 310 to network subscriber databases, i.e., UDM 323 of 5GC network 320 and to HSS 333 of EPC network 330, to store an SOC for WPS service and priority attributes in association with UE 310. Provisioning module 375 may also push a configuration update to UE 310 which includes QoS parameters, Access Class Barring (ACB) exemptions, IMS settings for VoLTE or VoNR support, and dialing instructions for WPS call initiation.

With a WPS status registered with EPC network 330 and 5GC network 320, UE 310 connects with RAN 331 (e.g., an eNodeB cell) for an IMS transmission, e.g. to place a WPS voice call. UE 310 registers with MME 332 of EPC 330, which processes the attach request and retrieves the subscriber profile from the HSS. MME 332 identifies or verifies the WPS status of the inbound call based on the SOC associated with UE 310’s profile. Upon detecting the WPS designation, MME 332 assigns a dedicated bearer with a high-priority Allocation and Retention Priority (ARP) value to expedite call setup. Once the call setup is complete, SGW 334 and PGW 336 route the WPS call toward IMS core 360. PGW 336 forwards IMS-bound traffic to a Proxy Call Session Control Function (P-CSCF) (not shown), which manages SIP signaling to connect the call with a PSAP, another UE, or similar endpoint.

Continuing the operational scenario of FIG. 3, UE 310 moves to a new location during the call and attaches to 5GC network 320 via RAN 321 (e.g., a gNodeB cell). When the WPS call is handed over from EPC network 330 to 5GC network 320, MME 332 initiates the handover by sending a handover request to AMF 322 including the subscriber’s SOC. AMF 332 queries UDM 323 to validate the subscriber’s WPS authorization and retrieve the corresponding 5G QoS Identifier (5QI) and priority settings. An NSSF (not shown) of 5GC network 320 then selects network slice 340 for priority communications based on the authorization. SMF 324 establishes a voice session within the WPS slice, mapping the voice bearer parameters from EPC network 330 to a high-priority 5QI flow with appropriate preemption settings. UPF 325 routes the traffic with low-latency handling during the IMS session.

In various implementations, the handover request is received for network service for transmissions other than IMS transmissions, such as IP traffic from UE 310. IP traffic can include Internet of Things (IoT) telemetry, emergency alert messaging, streaming media, or cloud-based application access. In some scenarios, rather than receiving a handover request to continue a call (or other service) from a UE 310, the request for network service is a registration request received from UE 310.

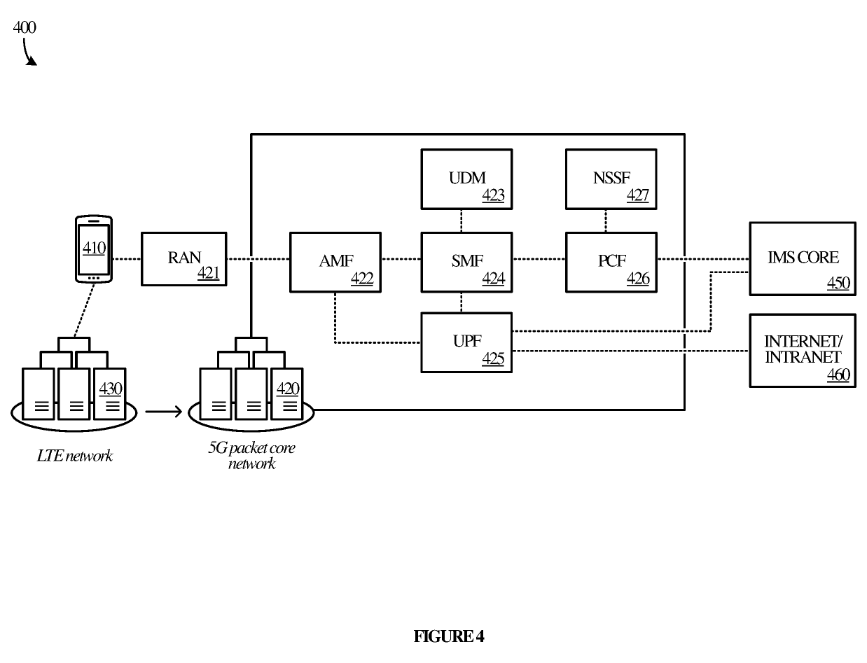

FIG. 4 illustrates operational environment 400 for enabling WPS using network slicing on a wireless communication network in an implementation. Operational environment 400 includes UE 410, LTE network 430, 5G packet core network (“5G network”) 420, RAN 421, IMS core 450, and data network 460. 5G packet core network 420 includes network functions AMF 422, UDM 423, SMF 424, UPF 425, PCF 426, and NSSF 427. 5G network 420 is representative of an SBA network including a 5G core of which 5GC 120 is representative. LTE network 430 is representative of an LTE or 5GNSA network including an evolved packet core of which EPC 130 of FIG. 1 is representative. RAN 421 is representative of an access node for carrying wireless communications between an endpoint and wireless network and of which RANs 121 and 131 are representative. Data network 460 is representative of an endpoint for IP data traffic, such as a destination on a public network (the Internet) or a private network or intranet.

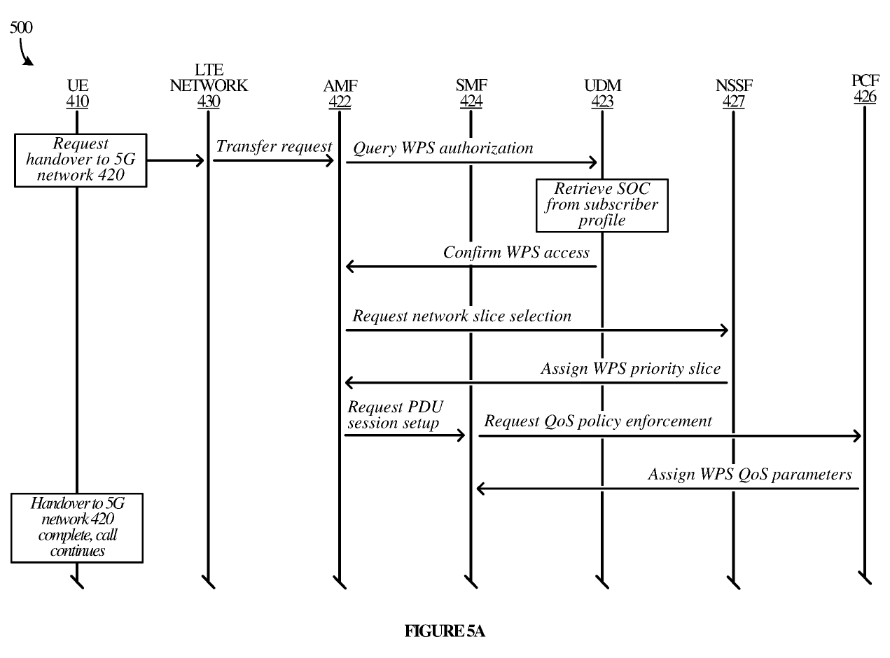

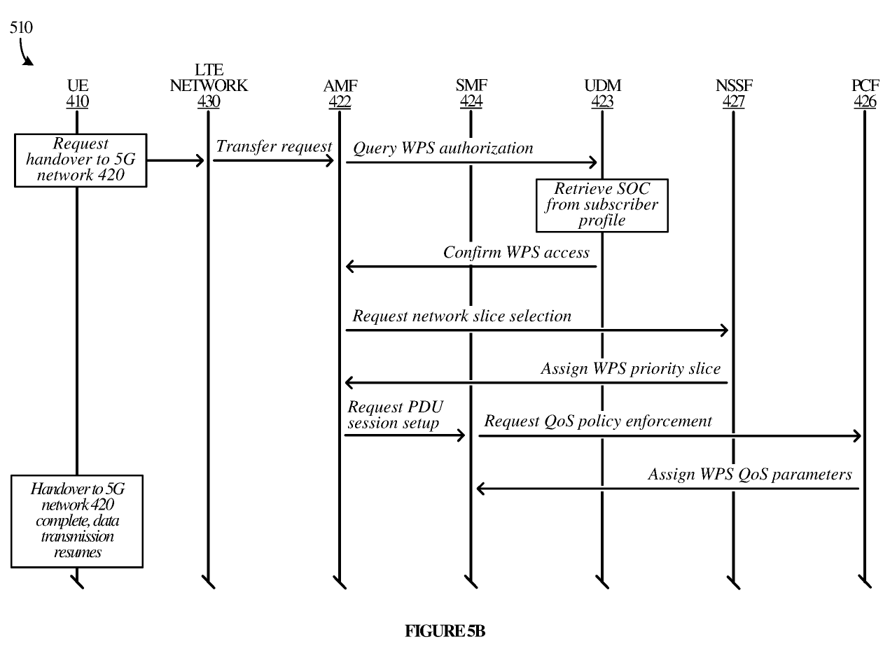

FIGS. 5A and 5B illustrate workflows 500 and 510, respectively, for enabling WPS using network slicing on a wireless communication network in an implementation, referring to elements of operational environment 400.

In workflow 500, UE 410, attached to LTE network 430, initiates a handover request. For example, UE 410 may detect a better 5G signal and send a handover request to LTE network 430 while maintaining its ongoing IMS-based WPS call. An LTE eNB (evolved Node B, not shown) forwards the handover request to an MME (not shown) of LTE network 430 (not shown), and LTE network 430 processes the handover request. The MME coordinates with AMF 422 in 5G network 420 to initiate the transition.

Next, AMF 422 receives the handover request and verifies UE 410’s WPS authorization by querying UDM 423. When AMF 422 receives the handover request from the LTE network, it sends an Nudm_UEAuthentication request message to UDM 423. UDM 423 retrieves the Service Offering Code (SOC) associated with the UE’s subscription profile. If the UE's SOC includes WPS entitlement, UDM 423 returns a confirmation response to AMF 422, specifying the allowed network slice(s) for WPS traffic, priority QoS parameters (e.g., ARP = 1–3, 5QI = 1 for real-time voice), preemption capability (i.e., whether the session preempt lower-priority traffic), and IMS-based voice service eligibility. If, however, UE 410's SOC does not include WPS entitlement, the response indicates that priority handling is not applicable, and the handover proceeds as a standard session.

Continuing workflow 500, UDM 423 checks the subscriber profile of UE 410 to confirm the WPS entitlement and returns the allowed network slices and QoS policies. For example, UDM 423 sends an Nudm_UEAuthentication response to the AMF 422, confirming whether WPS priority handling is granted or denied, the assigned network slice for WPS traffic (e.g., network slice 140 of FIG. 1), and the QoS parameters that must be enforced.

Based on UE 410's profile and service request, AMF 422 queries NSSF 427 to select the appropriate 5G network slice for the WPS session. NSSF 427 responds with the appropriate slice details (e.g., URLLC, mission-critical slice). AMF 422 triggers SMF 424 to establish a PDU session in the assigned network slice. SMF 424 allocates network resources based on PCF 426 policies to ensure WPS QoS standards are met. IMS core 450 handles session continuity during the transition. The SIP signaling for the IMS-based WPS call is updated to route the voice traffic over 5G network 420. PCF 426 applies priority QoS policies to ensure the WPS call maintains low latency and preemptive priority over other sessions. SMF 424 applies the QoS rules and activates the PDU session for the ongoing call. UE 410 switches to the 5G network and continues the WPS call over VoNR. IMS core 450 ensures media continuity, and the PDU session carries the IMS traffic with WPS priority handling.

In workflow 510 of FIG. 5B, UE 410 is actively transmitting WPS data over LTE network 430 and detects a better 5G signal or receives a network-initiated handover request. UE 410 sends a measurement report to LTE network 430, indicating 5G availability. UE 410 initiates a handover request.

LTE network 430 evaluates the request and decides to hand over the WPS data session to 5G network 420. An LTE eNB (not shown) communicates with the EPC MME (not shown), which then contacts AMF 422 to initiate the transition. AMF 422 in 5G network 420 receives the handover request from the MME and begins the process of session transfer.

AMF 422 queries UDM 423 to verify the UE’s subscription details, specifically checking WPS authorization based on the SOC in a manner similar to the one described in workflow 500. UDM 423 retrieves the SOC from UE 410’s subscriber profile. The SOC defines whether UE 410 is authorized for WPS priority handling in the 5G network, and specifies allowed network slices for WPS data, QoS priority level (e.g., ARP = 1-3, 5QI for mission-critical data), and preemption capability. UDM 423 sends the authorization confirmation to AMF 422, indicating whether WPS priority should be applied.

With WPS authorization is confirmed, AMF 422 sends a request to NSSF 427 to select the appropriate WPS-enabled network slice. NSSF 427 determines the best slice based on UE 410 capabilities, WPS-specific priority rules, and network conditions. NSSF 427 assigns a dedicated WPS slice (e.g., network slice 140) for the WPS data session. Once the slice is selected, AMF 422 notifies SMF 424 to establish a PDU session in 5G network 420.

SMF 424 initiates session setup with the appropriate QoS policies for WPS data. SMF 424 contacts PCF 426 to apply the necessary QoS policies based on the WPS service requirements. PCF 426 enforces priority treatment, ensuring a guaranteed bandwidth for WPS data, low latency, preemptive access, appropriate 5QI mapping for mission-critical WPS traffic. PCF 426 returns QoS policies to SMF 424. SMF 424 configures the session and assigns the required QoS settings. 5G network 420 completes session setup, and UE 410 is informed to start transmitting data over 5G network 420. UE 410 completes the transition from LTE network 430 to 5G network 430 and continues its WPS data transmission over the assigned network slice. 5G network 430 ensures QoS enforcement, allowing UE 410 to maintain high-priority service for mission-critical data.

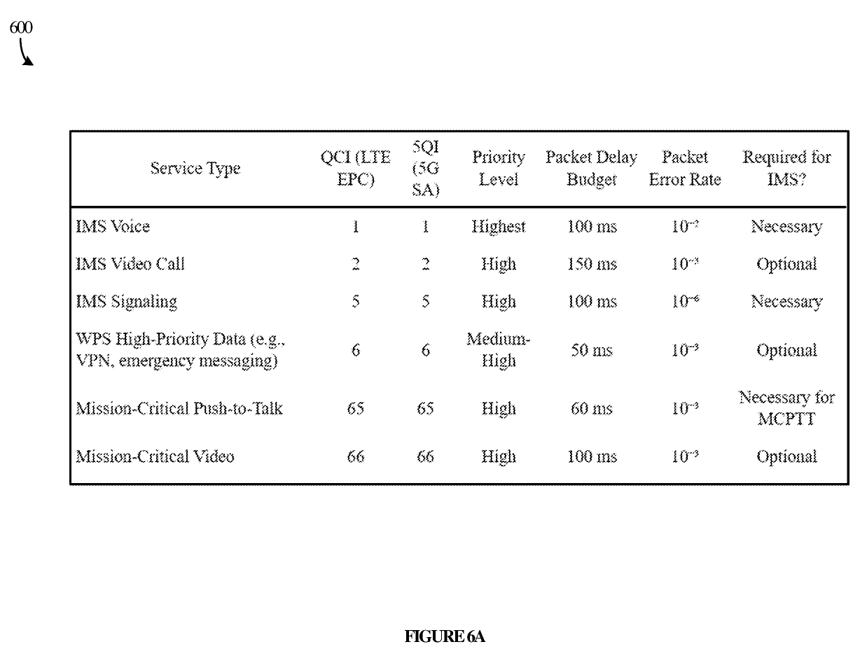

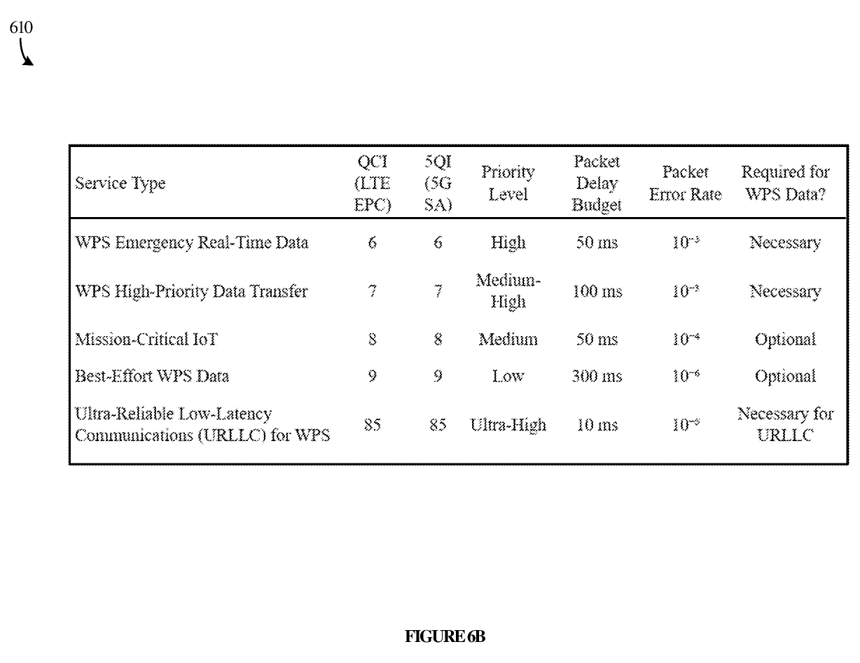

FIGS. 6A and 6B illustrate tables 600 and 610, respectively, of 5QI classes for dedicated network slices for WPS on an SBA network in an implementation. Table 600 includes 5QI classes, as mapped from QCI classes, for IMS and other high-priority services. Table 610 includes 5QI classes, as mapped from QCI classes, for IP data traffic and other high-priority services. In an implementation, classes designated as necessary are default classes of a WPS-dedicated network slice, while optional classes may be included in variations or alternative WPS-dedicated network slices according to the service required by the UE.

FIG. 7 illustrates exemplary wireless communication system 700 that serves wireless User Equipment (UE) 701 based on policies. Wireless communication system 700 includes UE 701, Wifi Access Node (AN) 703, 5GNR RAN 705, Interworking Function (IWF) 735, Access and Mobility Management Function (AMF) 734, Authentication Server Function (AUSF) 731, Unified Data Management (UDM) 732, Policy Control Functions (PCFs) 733, Session Management Function (SMF) 736, User Plane Function (UPF) 737, Uniform Data Repository (UDR) 738, and Application Function (AF) 750. UDR 738 stores network data which is accessible by UDM 732 and which includes subscriber profiles including identities, subscription details, service preferences, SOCs, authentication credentials, and billing information. AF 750 may provide policies applicable to control plane functions, that is, to the application, presentation, and/or session layers of the OSI protocol stack. IWF 735 includes non-3GPP IWFs (N3IWFs) for providing untrusted non-3GPP access to network data center 710, such as access via a non-cellular access network.

Continuing with wireless communication system 700, wireless network slice 740 includes RAN 705, UPF 737, and other network functions such as SMF 736. Wireless network slice 740 is representative of a dynamically allocated slice of finite duration selected for hosting service between DN 760 and UE 701 according to the technology disclosed herein, including process 200 or workflows 500 or 510. DN 760 is representative of a data network, Internet access, third-party resource, or other endpoint of an end-to-end communication path from UE 701. For example, DN 760 may be an application or application service for a priority service process for the wireless network of network data center 710 for service to UE 701.

In an implementation, UE 701 communicates with network data center 710 via 5G-NR access node 705 or Wifi access node 703. UE 701 requests access to DN 760 via the communication network of network data center 710, e.g., via wireless network slice 740. SMF 736 receives the access request from AMF 734 and other network functions of the communication network which are enforcing various aspects of the access request from UE 701. SMF 736 receives policies or policy decisions from AUSF 731, UDM 732, PCF 733, or AMF 734.

FIG. 8 illustrates exemplary network data center 830, a network core of a wireless communication system, such as 5GC network 120 of FIG. 1. Network data center 830 includes network function (NF) software 805, network function virtual layer 804, network function operating systems 803, network function hardware drivers 802, and network function hardware 801.

Network function software 805 of network data center 830 includes software for executing various network functions: IWF software 807, AMF software 809, UDM software 811, PCF software 813, SMF software 815, UPF software 817, and UDR software 819. Other network function software, such as network repository function (NRF) software, are typically present but are omitted for clarity.

Network function virtual layer 804 includes virtualized components of network data center 830, such as virtual NIC 851, virtual CPU 852, virtual RAM 853, virtual drive 854, virtual software 855, and virtual GPU 856. Network operating systems 803 includes components for operating network data center 830, including kernels 861, modules 862, applications 863, and containers 864 for network function software execution. Network function hardware drivers 802 include software for operating network function hardware 801 of network data center 830, including network interface card (NIC) drivers 871 for network interface cards (NICs) 881, CPU drivers 872 for CPUs 882, RAM drivers 873 for RAM 883, flash/disk drive drivers 874 for flash/disk drives 884, data switch (DSW) drivers 875 for data switches 885, and drivers 876 for GPUs 886. Network interface cards 881 of network function hardware 801 include hardware components for communicating with Wifi access node 891, 5GNR access node 892, PCF 893, application server 894, and UPF 895.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements priority service process 906, which is (are) representative of the priority service processes discussed with respect to the preceding Figures, such as process 200 and workflows 500 and 510. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including priority service process 906) may be implemented in program instructions and among other functions may, when executed by processing system 902, direct processing system 902 to operate as described with respect to the various operational scenarios, sequences, and processes illustrated herein. For example, software 905 may include program instructions for implementing a priority service process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support priority service processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words "comprise," "comprising," “such as,” and “the like” are to be construed in an inclusive sense, as opposed to an exclusive or exhaustive sense, that is to say, in the sense of "including, but not limited to.” As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for," but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive an access request for network service for a UE;
identify priority status of a subscriber profile of the UE;
assign a dedicated network slice based on the priority status; and
enable the network service for the UE in accordance with the dedicated network slice.

2. The computing apparatus of claim 1, wherein the priority status includes Wireless Priority Service (WPS) authorization.

3. The computing apparatus of claim 2, wherein the program instructions further direct the computing apparatus to provision a Service Offer Code (SOC) for WPS service to the subscriber profile of the UE.

4. The computing apparatus of claim 3, wherein to identify the priority status of the subscriber profile, the program instructions direct the computing apparatus to identify the SOC for WPS service of the subscriber profile of the UE.

5. The computing apparatus of claim 2, wherein the access request is a registration request received from the UE.

6. The computing apparatus of claim 2, wherein the access request is a handover request received from an evolved packet core (EPC) network.

7. The computing apparatus of claim 2, wherein the dedicated network slice comprises 5G Quality of Service Indicator classes mapped from Quality of Service Class Identifiers (QCI) classes identified for WPS.

8. The computing apparatus of claim 2, wherein the network comprises a service-based architecture (SBA) network.

9. A method of operating a wireless network comprising:
receiving an access request for network service for a UE;
identifying priority status of a subscriber profile associated with the UE;
assigning a dedicated network slice based on the priority status; and
enabling the network service for the UE in accordance with the dedicated network slice.

10. The method of claim 9, wherein the priority status includes Wireless Priority Service (WPS) authorization.

11. The method of claim 10, further comprising provisioning a Service Offer Code (SOC) for WPS service to the subscriber profile of the UE.

12. The method of claim 11, wherein identifying the priority status of the subscriber profile comprises identifying the SOC for WPS service of the subscriber profile of the UE.

13. The method of claim 10, wherein the access request is a registration request received from the UE.

14. The method of claim 10, wherein the access request is a handover request received from an evolved packet core (EPC) network.

15. The method of claim 10, wherein the dedicated network slice comprises 5G Quality of Service Indicator classes mapped from Quality of Service Class Identifiers (QCI) classes identified for WPS.

16. The method of claim 10, wherein the network comprises a service-based architecture (SBA) network.

17. One or more computer readable storage media having program instructions stored thereon that, when executed by one or more processors, direct a computing device to at least:
receive an access request for network service for a UE;
identify priority status of a subscriber profile of the UE;
assign a dedicated network slice based on the priority status; and
enable the network service for the UE in accordance with the dedicated network slice.

18. The one or more computer readable storage media of claim 17, wherein the priority status includes Wireless Priority Service (WPS) authorization.

19. The one or more computer readable storage media of claim 18, wherein the program instructions further direct the computing device to provision a Service Offer Code (SOC) for WPS service to the subscriber profile of the UE.

20. The one or more computer readable storage media of claim 19, wherein to identify the priority status of the subscriber profile of the UE, the program instructions direct the computing device to identify the SOC for WPS service of the subscriber profile of the UE.
